(19) United States
(12) Patent Application Publication
(10) Pub. No.: US 2005/0097226 A1
(43) Pub. Date: May 5, 2005

(54) Methods and apparatus for dynamically switching between polling and interrupt to handle network traffic

(75) Inventor: Sunay Tripathi, Santa Clara, CA (US)

Correspondence Address: BEYER WEAVER & THOMAS LLP, P.O. BOX 70250, OAKLAND, CA, 94612-0250, US

(73) Assignee: Sun Microsystems, Inc.

(21) Appl. No.: 10/698,211

(22) Filed: Oct. 31, 2003

(51) Int. Cl. G06F 15/16

(52) U.S. Cl. 709/250; 709/232

(57) ABSTRACT

Methods and apparatus for processing packets in a computer system including an operating system and a network interface card are disclosed. The network interface card is configured to operate in either a polling mode or an interrupt mode. When the network interface card is in the polling mode, the network interface card is periodically polled to determine whether one or more packets have been received. When the network interface card is in the interrupt mode, the operating system is capable of receiving an interrupt from the network interface card, the interrupt indicating that the network interface card has received one or more packets. The operating system is capable of instructing the network interface card to change its mode from the polling mode to the interrupt mode (e.g., when packets are being received infrequently by the network interface card), and from the interrupt mode to the polling mode (e.g., when packets are received more frequently by the network interface card). Packets that are received may then be processed by the operating system.

### BACKGROUND

An operating system generally includes a kernel, which is the core of the computer operating system. The kernel's services may be requested by other parts of the operating system or by an application through a system call routine.

At the top of the network protocol stack, applications are generally written to function through the use of a specific network protocol. The application developer then needs to write a different version of the application for it to operate using different network protocols. Many developers have overcome these issues by writing applications based upon a common or standard interface, such as NetBIOS, WinSock, or BSD sockets. Generally, these interfaces communicate directly with the socket layer of the kernel. The socket layer was designed to provide independence from the network communication layer and interfaces with system call routines that interface to the kernel.

The kernel includes the socket layer and the network protocol stack. In addition, a Network Interface Card (NIC) Driver capable of communicating with a NIC is in communication with the kernel via a standard interface such as a Data Link Provider Interface.

Traditionally, when a NIC receives a packet over the network, the NIC issues an interrupt. The driver notifies the operating system kernel of the interrupt. The kernel processes the interrupt and obtains the packet from the NIC via the driver. As each packet is subsequently received by the NIC, the NIC generates an interrupt. Thus, the operating system kernel obtains each packet from the NIC as interrupts are generated. Accordingly, packets that are received by the NIC are processed immediately by the operating system kernel.

A server is typically contacted by a client when data is requested from the server. Thus, the server's primary responsibility is to respond to each server request with the requested data. Unfortunately, since the server is required to respond immediately to interrupts generated when packets are received, this received data is given a higher priority than that given to packets that are transmitted by the server. Accordingly, a client receiving packets from a server may perceive a substantial delay as packets are being transmitted by the server.

### SUMMARY

The present invention enables a network interface card to be operated in multiple modes, enabling its ability to interrupt a CPU to be controlled. Specifically, the modes of the network interface card may be controlled by an operating system kernel. In this manner, the operating system kernel may disable or enable interrupt processing of the network interface card, thereby enabling the performance of the server to be optimized.

In accordance with one aspect of the invention, methods and apparatus for processing packets in a computer system including an operating system and a network interface card are disclosed. When the network interface card is in a polling mode, the operating system kernel polls the network interface card to determine whether one or more packets have been received. When the network interface card is in an interrupt mode, the CPU is capable of receiving an interrupt from the network interface card that indicates that the network interface card has received one or more packets. Packets that have been received by the network interface card may then be obtained from the network interface card and processed.

In accordance with another aspect of the invention, the operating system is configured to instruct the network interface card to operate in the polling mode or the interrupt mode. In accordance with one embodiment, the operating system controls the operating mode of the network interface card such that the network interface card is in the polling mode during periods of heavy network traffic and in the interrupt mode during periods of light to moderate network traffic. Specifically, the operating system dynamically instructs the network interface card to operate in a first mode when packets are received by the network interface card at less than a predefined rate, the network interface card in the first mode being capable of interrupting a CPU when a packet is received by the network interface card. Similarly, the operating system instructs the network interface card to operate in a second mode when packets are received by the network interface card at greater than a predefined rate, the network interface card in the second mode being disabled from interrupting the CPU when a packet is received by the network interface card. Accordingly, for a network intensive workload, the system will likely remain in the polling mode.

In accordance with yet another aspect of the invention, a computer system includes an operating system and a network interface card coupled to the operating system, where the network interface card is configured to operate in an interrupt mode when in a first state and to operate in polling mode when in a second state, the network interface card when in the interrupt mode being configured to interrupt the operating system when a packet is received by the network interface card over a network. When in the polling mode, the network interface card may be disabled from issuing an interrupt entirely, or in specific circumstances (e.g., for packets having normal to low priority).

In accordance with one embodiment, the computer system includes a CPU having an associated queue and a network interface card having an associated buffer. When an interrupt is received from the network interface card, a set of one or more packets are transferred from the buffer associated with the network interface card to the queue associated with the CPU. Similarly, upon polling the network interface card, if it is determined that one or more packets have been received by the network interface card, the one or more packets in the buffer associated with the network interface card are transferred to the queue associated with the CPU. Each of the packets in the queue associated with the CPU are then processed. Since the set of packets may be transferred simultaneously as a chain of packets (e.g., linked list), the performance of the server is improved.

In accordance with an embodiment of the invention, the ability of a network interface card to interrupt a specific CPU is set forth. In addition, the packets in the buffer of the network interface card may be transferred by the operating system to the queue associated with the specific CPU. This is accomplished by assigning a single network interface card identifier to map the CPU and its associated queue to a network interface card and its associated buffer. In this manner, packets may be efficiently transferred from the network interface card to the queue for processing by the CPU.

The embodiments of the invention may be implemented software, hardware, or a combination of hardware and software. The invention can also be embodied as computer readable code on a computer readable medium. In addition, data structures disclosed are also part of the invention.

### BRIEF DESCRIPTION OF THE DRAWINGS

Embodiments of the invention may best be understood by reference to the following description taken in conjunction with the accompanying drawings in which:

FIG. 1 is a block diagram illustrating a computer system including a prior art Network Interface Card (NIC).

FIG. 2 is a block diagram illustrating a system in which the present invention may be implemented in accordance with one embodiment of the invention.

FIG. 3 is a process flow diagram illustrating a general method of performing polling to handle network traffic in accordance with one embodiment of the invention.

FIG. 4 is a process flow diagram illustrating one method of performing polling to handle network traffic in accordance with one embodiment of the invention.

FIG. 5 is a process flow diagram illustrating one method of initializing the NIC as shown at block 404 of FIG. 4 to support dynamic polling in accordance with one embodiment of the invention.

FIG. 6 is a block diagram illustrating a typical, general-purpose computer system suitable for implementing the present invention.

### DETAILED DESCRIPTION

In the following description for embodiments of the invention, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

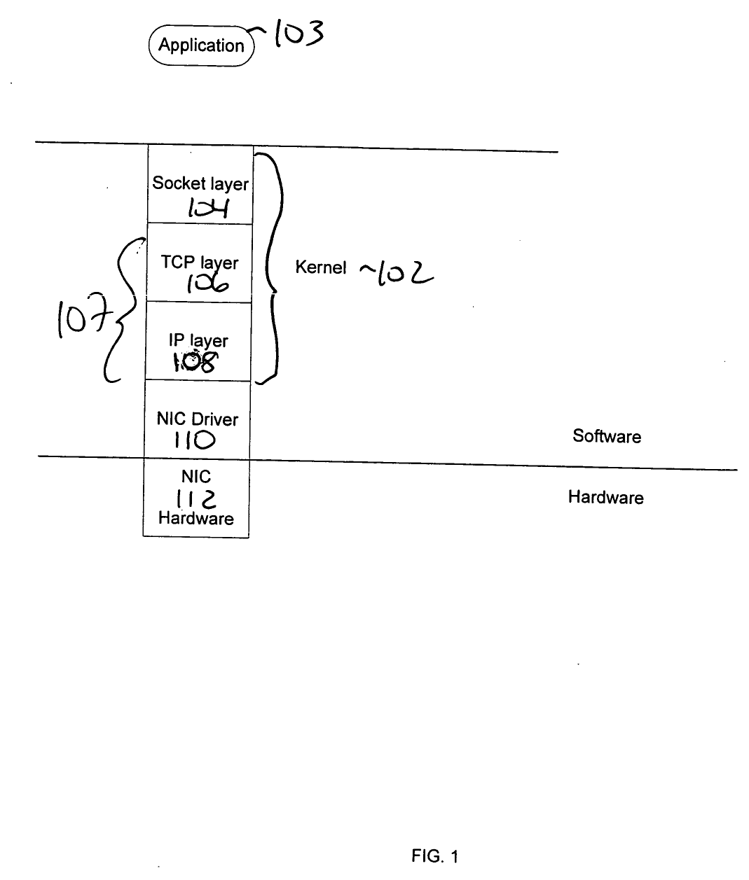

As shown in FIG. 1, an exemplary operating system includes a kernel 102. The kernel is the core of the computer operating system. The kernel's services may be requested by other parts of the operating system or by an application 103 through a system call routine.

At the top of the network protocol stack 107, applications 103 are generally written to function through the use of a specific network protocol. The application developer then needs to write a different version of the application for it to operate using different network protocols. Many developers have overcome these issues by writing applications based upon a common or standard interface, such as NetBIOS, WinSock, or BSD sockets. Generally, these interfaces communicate directly with the socket layer 104 of the kernel. The socket layer was designed to provide independence from the network communication layer and interfaces with system call routines that interface to the kernel 102.

The kernel 102 includes the socket layer 104 and the network protocol stack 107, which includes a TCP layer 106 and an IP layer 108. Specifically, the TCP layer 106 is capable of performing a TCP three way handshake to establish a TCP connection., and manages the assembling of a message or file into packets that may be transmitted over the Internet during the TCP connection. The IP layer 108 handles the addressing for each packet. In addition, a Network Interface Card (NIC) Driver 110 capable of communicating with a NIC 112 is in communication with the kernel 102 via a standard interface such as a Data Link Provider Interface.

Traditionally, when a NIC 112 receives a packet over the network, the NIC 112 issues an interrupt. The driver 110 notifies the operating system kernel 102 of the interrupt. The kernel 102 processes the interrupt and obtains the packet from the NIC 112 via the driver 110. As each packet is subsequently received by the NIC 112, the NIC 112 generates an interrupt. Thus, the operating system kernel 102 obtains each packet from the NIC 112 as interrupts are generated. Accordingly, packets that are received by the NIC 112 are processed immediately by the operating system kernel 102.

As a NIC receives packets over the network, it typically generates interrupts. While an interrupt is practical in high priority situations that occur infrequently, an interrupt is not practical for low priority situations that occur frequently.

In electronic communication, ‘polling’ is the periodic checking of other programs or devices by one program or device to see what state they are in, usually to see whether they are still connected or want to communicate. Specifically, a controlling device attached to another device sends a message to the device periodically, asking whether it has anything to communicate.

Polling is a viable option for use in situations that are low-priority situations that occur frequently. For instance, the NIC could be placed in polling mode, and any packets received by the NIC could be obtained periodically from the NIC. However, permanently placing the NIC in polling mode would potentially result in a substantial delay for those packets that are received by the NIC.

In accordance with one embodiment of the invention, the NIC is configured for operating in two modes: polling mode and interrupt mode. Specifically, when the NIC is in the polling mode, the operating system kernel periodically polls the NIC to determine whether one or more packets have been received. When the NIC is in the interrupt mode, the NIC issues an interrupt when the NIC has received one or more packets that need to be handled by the operating system kernel.

In accordance with another embodiment of the invention, the operating system is capable of instructing the NIC to operate in either the polling mode or the interrupt mode. Specifically, the network interface card is instructed to operate in the polling mode when packets are being received frequently by the network interface card, while the network interface card is instructed to operate in the interrupt mode when packets are being received infrequently by the network interface card. Frequency may be established through establishing a predefined numerical threshold value, such as the number of packets received per second by the NIC. For instance, when the number of packets per second being received by the network interface card is less than a predefined number of packets, then network interface card may be instructed to operate in the interrupt mode. Similarly, when the number of packets per second being received by the network interface card is greater than or equal to a predefined number of packets, then the network interface card may be instructed to operate in the polling mode. In another embodiment of the invention, if the operating system is already processing a packet received earlier or to be transmitted and there are more queued packets in the queue of the CPU, the NIC is instructed to operate in polling mode.

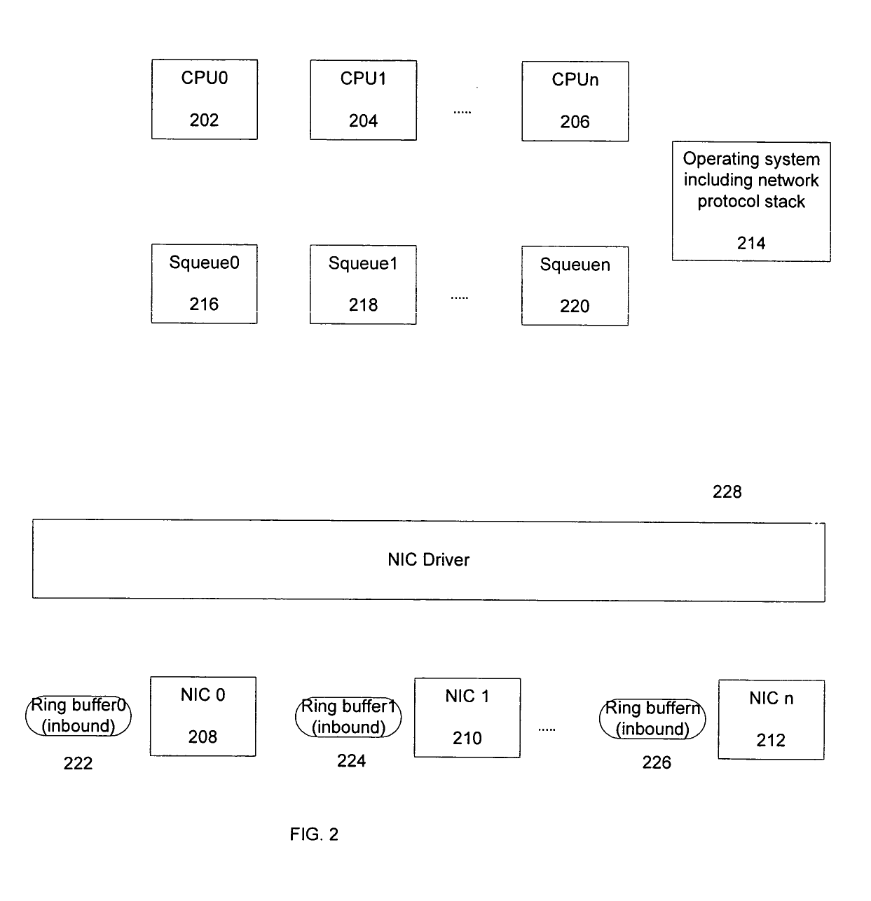

FIG. 2 is a block diagram illustrating a system in which the present invention may be implemented in accordance with one embodiment of the invention. As shown, the computer system may include one or more Central Processing Units (CPUs) shown as CPU0 202, CPU1 204, and CPUn 206. In addition, the system may include one or more network interface cards (NICs) shown as NIC0 208, NIC1 210, and NICn 212. In accordance with one embodiment, the mode (e.g., interrupt, polling) of a particular NIC is established in association with one or more of the CPUs. In this manner, it is possible to instruct a NIC whether it is permitted to interrupt a particular CPU, while still enabling the NIC to interrupt other CPUs.

Operating system 214 includes an operating system kernel having a network protocol stack. For instance, the network protocol stack may be a TCP/IP stack. The operating system also includes an interrupt handler. Generally, an interrupt handler prioritizes interrupts that are received by the operating system and saves them in a queue if more than one is waiting to be handled. When an interrupt is received from one of the NICs 208, 210, 212, the interrupt is prioritized in the queue. A scheduler of the operating schedules the operation of different programs as the interrupts are received.

Generally, when a hardware device generates an interrupt, the interrupt has a value that associates it with a particular device. Thus, the interrupt value identifies the one of the NICs. In accordance with one embodiment, the interrupt value also identifies the one of the CPUs being interrupted. For example, a single interrupt identifier (i.e., NIC or interrupt identifier) may be used to map a particular NIC to a particular CPU. Thus, through the use of this identifier, both the NIC and the CPU being interrupted may be identified by the operating system kernel receiving the interrupt.

As shown in FIG. 2, in accordance with one embodiment, each of the CPUs 202, 204, 206 has an associated queue Squeue0 216, Squeue1 218, and Squeue n 220, respectively, for storing packets. The queue may store inbound and/or outbound packets. In addition, each of the NICs 208, 210, 212 has an associated memory (e.g., ring buffer) for storing inbound packets as they are received over a network. Thus, as shown each of the NICs 208, 210, 212 has an associated ring buffer 222, 224, and 226, respectively.

In accordance with one embodiment, each of the queues Squeue0 216, Squeue1 218, Squeue n 220 associated with one of the CPUs 202, 204, 206 is capable of storing both inbound packets and outbound packets. As a result, both inbound packets and outbound packets are given equal priority. For instance, each of the queues Squeue0 216, Squeue1 218, Squeue n 220 may be a serialization queue such as that disclosed in the Patent Application entitled “A System and Method for Vertical Perimeter Protection,” naming Sunay Tripathi and Bruce Curtis as inventors, filed on Oct. 10, 2003, which is incorporated herein by reference for all purposes.

As described above, the interrupt value (i.e., NIC or interrupt identifier) may be used to identify both one of the CPUs 202, 204, 206 and one of the NICs 208, 210, 212. In addition, the identifier may be further mapped to one of the queues 216, 218, 220 associated with one of the CPUs 202, 204, 206. Moreover, the identifier may be further used to map the identifier to one of the ring buffers 222, 224, 226. For instance, it may be desirable to map one of the queues 216, 218, 220 to one of the ring buffers 222, 224, 226 to facilitate the transfer of packets from one of the ring buffers to one of the queues. In accordance with one embodiment, a single identifier is used to map one of the CPUs 202, 204, 206 and its associated queue 216, 218, or 220 with one of the NICs 208, 210, 212 and its associated buffer 222, 224, or 226.

Communication between the CPUs 202, 204, 206 and the NICs 208, 210, 212 may be achieved through the use of a driver 228. In accordance with one embodiment, the driver includes one or more application programming interfaces (APIs) (e.g., CHANGE_INTERRUPT) to enable the operating system kernel to instruct one of the NICs 208, 210, 212 to change its mode from the interrupt mode to the polling mode, or from the polling mode to the interrupt mode. In addition, an API (e.g., GET_PACKETS) may be provided that enables the operating system kernel to move a set of packets from one of the buffers 222, 224, 226 associated with one of the NICs 208, 210, 212 to one of the queues 216, 218, 220 associated with one of the CPUs 202, 204, 206. Thus, the operating system kernel may instruct a NIC to change its mode from interrupt mode to polling mode, or from polling mode to interrupt mode. In response, the NIC enters the polling mode or the interrupt mode, as instructed.

In addition, it may be desirable for the operating system to ascertain whether the network interface card is in an interrupt mode or a polling mode. The operating system, once aware of the state of the network interface card, may then operate accordingly. Specifically, when the NIC is in the polling mode, the operating system polls the NIC periodically for packets that may have been received. When the NIC is in the interrupt mode, the operating system operates to retrieve packets when an interrupt is received from the NIC.

As described above, the NIC is capable of operating in two different modes. However, this example is merely illustrative, and other additional modes may also be implemented. Moreover, it is also possible that the interrupt mode and the polling mode be implemented in different manners. Generally, the NIC generates an interrupt when a packet is received while operating in the interrupt mode, but cannot generate an interrupt when a packet is received while operating in the polling mode. Alternatively, when the NIC is in the polling mode, the NIC may generate an interrupt when a packet is received, but only for packets deemed to have a high priority (not for packets deemed to have a low priority). High priority may refer to a single priority or may refer to a range of priorities of packets.

Specifically, in accordance with one embodiment, the network interface card when in the interrupt mode is configured to interrupt the operating system when a packet is received by the network interface card over a network. When the network interface card is in the polling mode, the NIC is unable to interrupt the operating system, thereby enabling the operating system to poll the network interface card to obtain packets from the network interface card. In accordance with another embodiment, the network interface card is unable to interrupt the operating system when in the polling mode for packets having low priority, but continues to be able to interrupt the system when in the polling mode for packets having high priority.

As described above, a NIC is capable of operating in two different modes. These modes may be entered upon initialization (e.g., boot up), upon instruction from an external source (e.g., CPU or driver associated with the NIC), or upon instruction internally from within the NIC. For instance, the NIC may choose to alter its mode of operation due to an external (e.g., busy or non-busy state) or internal factor (e.g., hardware error). It is also contemplated that the NIC may enter a mode of operation permanently (e.g., until further instruction) or temporarily (e.g., for a specified period of time). Thus, the CPU may instruct the NIC to enter the polling mode or the interrupt mode for a specified period of time, after which it returns to its previous mode of operation. Alternatively, the CPU may instruct the NIC to enter a mode of operation through the use of a specific instruction to enter that mode, or through the use of a toggle operation to cause the NIC to enter the mode of operation that is opposite to its current mode of operation.

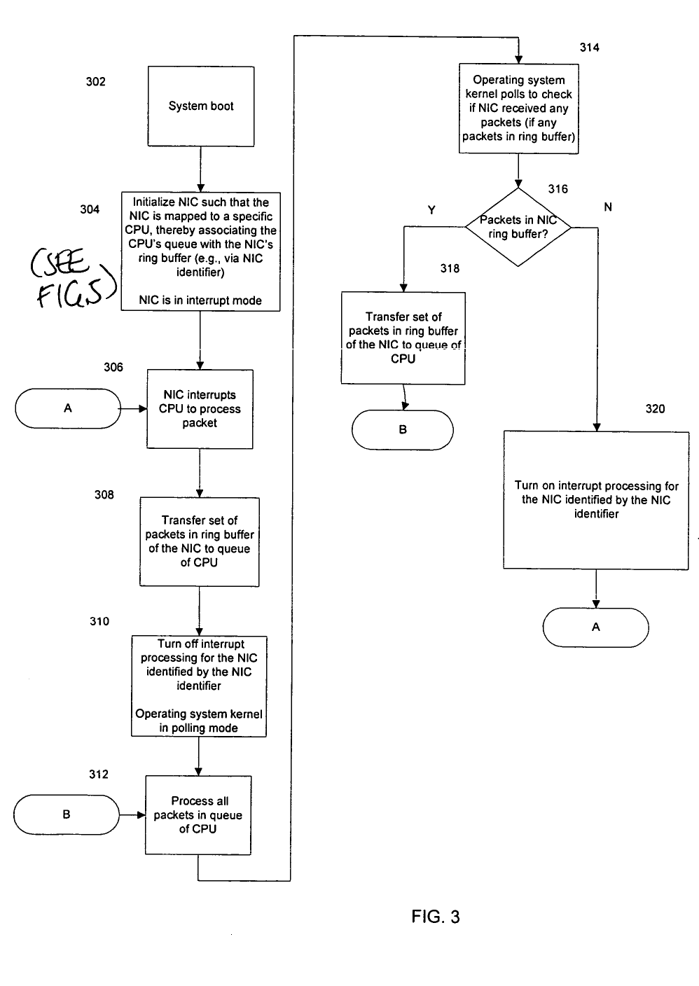

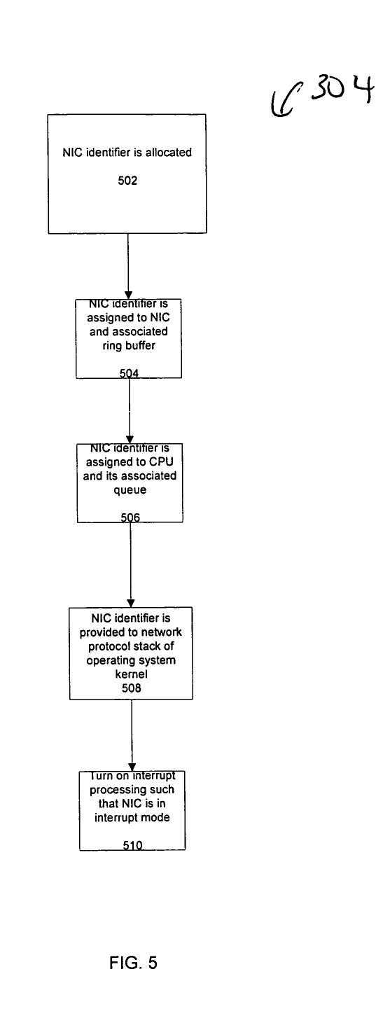

FIG. 3 is a process flow diagram illustrating a general method of performing polling to handle network traffic in accordance with one embodiment of the invention. As described above, a NIC and its associated buffer may be mapped to a CPU and its associated queue. In accordance with one embodiment, this mapping is performed during initialization of the computer system. Thus, when the computer system is booted at block 302, the NIC is initialized at block 304 such that the NIC is mapped to a specific CPU, thereby associating the CPU's queue with the NIC's ring buffer. This may be accomplished through the use of a NIC identifier as described above with reference to FIG. 2. One method of initializing the system to accomplish such a mapping will be described in further detail below with reference to FIG. 5. Since the NIC identifier identifies a particular CPU, the NIC is made aware of which CPU it is going to interrupt. Upon receiving the NIC identifier, the operating system kernel stores the NIC identifier (e.g., during initialization or upon receiving an interrupt) such that the NIC identifier is associated with an interrupted CPU and its associated queue. As described above the NIC identifier may also identify the receive buffer (as well as interrupt line) for the NIC. In addition, the NIC may be initialized such that it initially operates in interrupt mode.

Assuming that the NIC is operating in interrupt mode, the NIC interrupts the CPU to process a received packet at block 306. When an interrupt is received from the NIC, a set of one or more packets are transferred from the ring buffer associated with the NIC to the queue associated with the CPU at block 308. In accordance with one embodiment, the set of packets are transferred simultaneously. For instance, a pointer to a linked list of packets may be added to the queue of packets associated with the CPU.

The NIC then switches to the polling mode at block 310. For instance, the NIC may be switched to the polling mode when the interrupt is received from the NIC (or shortly thereafter) or prior to processing the packets in the queue. Specifically, in accordance with one embodiment, the kernel of the operating system instructs the NIC to enter the polling mode. For instance, the NIC identified by the NIC identifier may be instructed to enter the polling mode from the interrupt mode. Thereafter, the kernel of the operating system operates to poll the NIC periodically.

After the packets are retrieved from the ring buffer of the NIC, the operating system kernel processes each of the packets in the queue of the CPU at block 312. Since the queue contains both inbound and outbound packets, the CPU equally prioritizes inbound and outbound packets.

Once all of the packets in the queue of the CPU have been processed, the operating system kernel polls the NIC to determine if the NIC received one or more packets at block 314. For instance, the operating system kernel, the driver and/or the NIC may ascertain whether there are any packets in the ring buffer associated with the NIC. This may be accomplished, for example, by querying the NIC identified by a specific NIC identifier.

If one or more packets have been received by the network interface card as shown at block 316 (e.g., if any packets are in the ring buffer of the NIC), the one or more packets in the buffer associated with the network interface card are transferred to the queue associated with the CPU as shown at block 318. The operating system continues to process each of the packets in the queue associated with the CPU at block 312.

If no more packets have been received by the network interface card (e.g., no packets are in the ring buffer associated with the NIC) at block 316, the network interface card is instructed to switch from the polling mode to the interrupt mode at block 320. For instance, as described above, the NIC identified by a specific NIC identifier may be instructed to switch from the polling mode to the interrupt mode. The process then continues at block 306 to process interrupts as they are received.

As described above, both inbound and outbound packets present in the queue associated with the CPU are processed. These packets may be associated with multiple network connections as well as a single network connection.

The described embodiments may be implemented in a variety of programming languages. In accordance with one embodiment, the described embodiments are implemented in an object-oriented programming language.

Languages that support object-oriented programming also accommodate and encourage multithreading in several ways. For example, Java™ supports multithreading by including synchronization modifiers in the language syntax, by providing classes developed for multithreading that can be inherited by other classes, and by performing background “garbage collection” (recovering data areas that are no longer being used) for multiple threads. Thus, in accordance with one embodiment, one or more threads are instantiated for execution of the described embodiments.

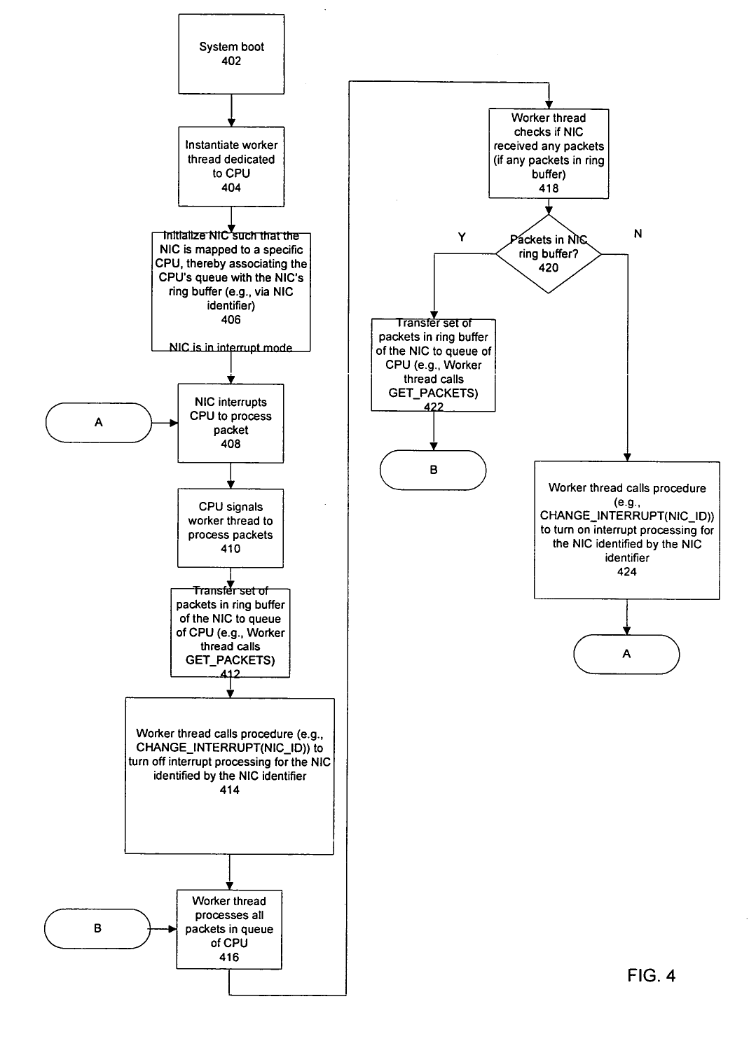

FIG. 4 is a process flow diagram illustrating one method of performing polling to handle network traffic in accordance with one embodiment of the invention. Specifically, one or more worker threads are instantiated for execution of the above-described method. As shown at block 402, the computer system is rebooted. At that time, one or more worker threads are instantiated at block 404. In accordance with one embodiment, the worker threads are dedicated to a particular CPU.

At the time the system is rebooted, the system is initialized at block 406 such that the NIC is mapped to a specific CPU, thereby associating the CPU's queue with the NIC's ring buffer. This may be accomplished through the use of a common identifier, as described above. In addition, the system is initialized such that the NIC is in interrupt mode.

When the NIC interrupts the CPU to process a packet at block 408, the CPU signals a worker thread (e.g., dedicated to the CPU) to process packets at block 410. The worker thread may be dedicated to processing all packets for the CPU, or merely dedicated to processing packets in the queue associated with the CPU. Specifically, the worker thread transfers a set of packets in the ring buffer of the NIC to the queue of the CPU at block 412. In accordance with one embodiment, the worker thread calls a procedure GET_PACKETS with the NIC identifier as a parameter to transfer the packets from the ring buffer of the NIC to the queue of the CPU. As described above, the NIC identifier maps the CPU and its associated queue to the NIC and its associated ring buffer. The worker thread then calls a procedure CHANGE_INTERRUPT at block 414 with the NIC identifier as a parameter and a boolean value to turn off interrupt processing for the NIC identified by the NIC identifier (and its associated CPU). In this manner, the NIC is instructed to enter the polling mode. For instance, the NIC may be instructed to enter the polling mode when the interrupt is received or shortly thereafter. In addition, the worker thread processes each of the packets in the queue of the CPU at block 416.

When the worker thread is done processing all of the packets in the CPU's queue, it ascertains whether the NIC has received any additional packets at block 418. For instance, the ring buffer associated with the NIC may be checked to determine whether there are any packets in the ring buffer at block 418.

If more packets have been received by the NIC (e.g. there are any additional packets in the ring buffer) at block 420, the worker thread again calls the procedure GET_PACKETS at block 422 to transfer the set of packets in the ring buffer of the NIC to the queue associated with the CPU, as described above. The process then continues as shown at block 416 and the worker thread processes each of the packets in the queue of the CPU.

Once it is determined that the NIC has not received any additional packets (e.g., there are no additional packets in the ring buffer), the worker thread calls the procedure CHANGE_INTERRUPT at block 424 with the NIC identifier and a boolean value as a parameter to turn on interrupt processing for the NIC identified by the NIC identifier (and its associated CPU). In this manner, the NIC is instructed to enter the interrupt mode. Thus, the NIC is instructed to switch to the interrupt mode when no packets are in the queue associated with the CPU or the buffer associated with the NIC. The process then continues at block 408 as interrupts are received by the CPU.

In accordance with another embodiment, the worker thread is solely responsible for processing packets in the queue of the CPU. Thus, a second worker thread is instantiated for the purpose of transferring the packets from the ring buffer of the NIC to the queue of the CPU via the GET_PACKETS procedure. This second worker thread is also responsible for TCP/IP processing of the packets. Once the chain of packets has been transferred to the queue of the CPU, the original worker thread processes the packets.

FIG. 5 is a process flow diagram illustrating one method of initializing the NIC as shown at block 406 of FIG. 4 to support dynamic polling in accordance with one embodiment of the invention. As described above, in accordance with one embodiment, a NIC identifier is used to map a CPU and its associated queue to a NIC and its associated ring buffer. Thus, a NIC identifier is allocated at block 502. The NIC identifier is assigned to a NIC and associated ring buffer 504. In addition, the NIC identifier is assigned to a CPU and its associated queue at block 506. In this manner, a single NIC identifier is associated with a CPU and its associated queue, as well as associated with a NIC and its associated ring buffer. The NIC identifier is then provided to the network protocol stack of the operating system kernel at block 508, as well as to the NIC. In this manner, the operating system kernel and the NIC may communicate with each other using the NIC identifier. Interrupt processing is then initiated such that the NIC is in interrupt mode at block 510.

The above-described embodiments enable a NIC and its mode of operation to be controlled by an operating system kernel. Specifically, the ability of a NIC to interrupt a CPU may be disabled or enabled. This mode of operation may be a general mode of operation. Alternatively, this mode of operation may be specific to the handling of packets received by the NIC. In other words, in accordance with one embodiment, an interrupt may be generated by the NIC for purposes other than notifying the operating system kernel that a packet has been received, even when the NIC is in the polling mode.

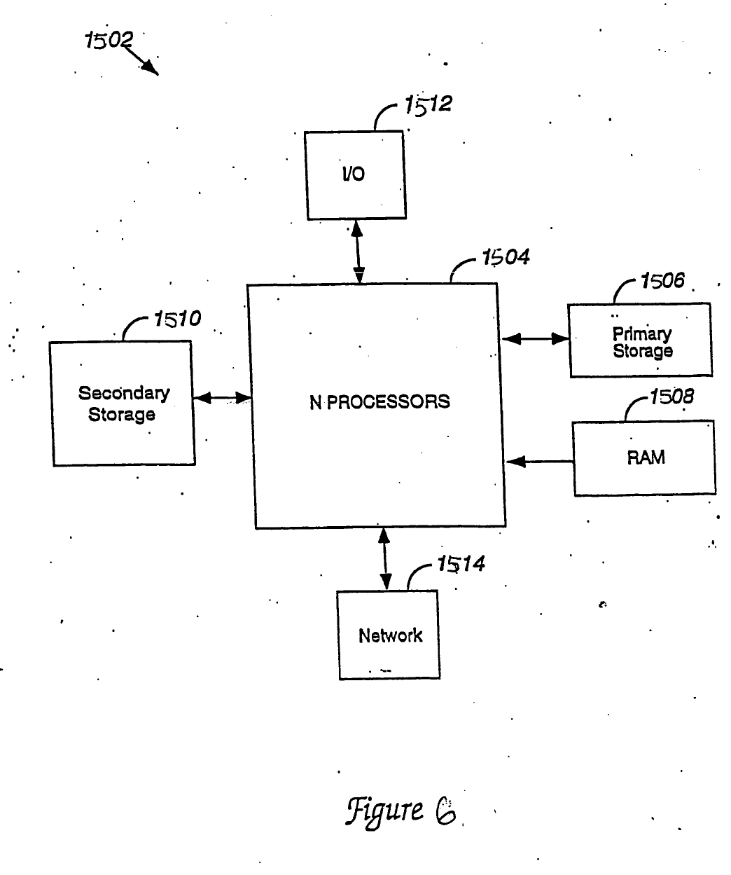

The present invention may be implemented on any suitable computer system. FIG. 6 illustrates a typical, general-purpose computer system 1502 suitable for implementing the present invention. The computer system may take any suitable form.

Computer system 1530 or, more specifically, CPUs 1532, maybe arranged to support a virtual machine, as will be appreciated by those skilled in the art. The computer system 1502 includes any number of processors 1504 (also referred to as central processing units, or CPUs) that may be coupled to memory devices including primary storage device 1506 (typically a read only memory, or ROM) and primary storage device 1508 (typically a random access memory, or RAM). As is well known in the art, ROM acts to transfer data and instructions uni-directionally to the CPUs 1504, while RAM is used typically to transfer data and instructions in a bi-directional manner. Both the primary storage devices 1506, 1508 may include any suitable computer-readable media. The CPUs 1504 may generally include any number of processors.

A secondary storage medium 1510, which is typically a mass memory device, may also be coupled bi-directionally to CPUs 1504 and provides additional data storage capacity. The mass memory device 1510 is a computer-readable medium that may be used to store programs including computer code, data, and the like. Typically, the mass memory device 1510 is a storage medium such as a hard disk which is generally slower than primary storage devices 1506, 1508.

The CPUs 1504 may also be coupled to one or more input/output devices 1512 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, the CPUs 1504 optionally may be coupled to a computer or telecommunications network, e.g., an internet network or an intranet network, using a network connection as shown generally at 1514. With such a network connection, it is contemplated that the CPUs 1504 might receive information from the network, or might output information to the network in the course of performing the above-described method steps. Such information, which is often represented as a sequence of instructions to be executed using the CPUs 1504, may be received from and outputted to the network, for example, in the form of a computer data signal embodied in a carrier wave.

Although illustrative embodiments and applications of this invention are shown and described herein, many variations and modifications are possible which remain within the concept, scope, and spirit of the invention, and these variations would become clear to those of ordinary skill in the art after perusal of this application. For instance, although the above-described embodiments are set forth in relation to the use of a single NIC driver, these embodiments are merely illustrative. Accordingly, the described embodiments may be implemented with respect to a variety of systems and may therefore be implemented with a greater number of drivers. For instance, a driver may be implemented in association with each NIC. Moreover, the above described process blocks are illustrative only. Therefore, the communication between the computer operating system and each NIC may be performed using alternate process blocks as well as alternate data structures. Accordingly, the present embodiments are to be considered as illustrative and not restrictive, and the invention is not to be limited to the details given herein, but may be modified within the scope and equivalents of the appended claims.

1. A method of configuring a network interface card, comprising:
instructing the network interface card to operate in a first mode when packets are received by the network interface card at less than a predefined rate, the network interface card in the first mode being capable of interrupting a CPU when a packet is received by the network interface card; and
instructing the network interface card to operate in a second mode when packets are received by the network interface card at greater than a predefined rate, the network interface card in the second mode being disabled from interrupting the CPU when a packet is received by the network interface card.

2. A method of processing packets in a computer system including an operating system and a network interface card, comprising:
polling the network interface card to determine whether one or more packets have been received when the network interface card is in a polling mode; and
receiving an interrupt from the network interface card when the network interface card is in an interrupt mode, the interrupt indicating that the network interface card has received one or more packets.

3. The method as recited in claim 2, further comprising:
obtaining packets from the network interface card and processing the packets obtained from the network interface card.

4. The method as recited in claim 2, wherein the operating system is configured to instruct the network interface card to operate in the polling mode or the interrupt mode.

5. The method as recited in claim 2, further comprising:
instructing the network interface card to operate in the polling mode when packets are being received frequently by the network interface card; and
instructing the network interface card to operate in the interrupt mode when packets are being received infrequently by the network interface card.

6. The method as recited in claim 2, further comprising:
instructing the network interface card to operate in the polling mode when a number of packets received per second by the network interface card is greater than a predefined number; and
instructing the network interface card to operate in the interrupt mode when the number of packets received per second by the network interface card is less than the predefined number.

7. The method as recited in claim 2, wherein the computer system has one or more CPUs, and wherein the mode of the network interface card is established in association with one or more of the CPUs.

8. The method as recited in claim 2, the network interface card when in the interrupt mode being configured to interrupt the operating system when a packet is received by the network interface card over a network, the network interface card being unable to interrupt the operating system when in the polling mode, thereby enabling the operating system to poll the network interface card to obtain packets from the network interface card when the network interface card is in the polling mode.

9. The method as recited in claim 2, the network interface card when in the interrupt mode being configured to interrupt the operating system when a packet is received by the network interface card over a network, the network interface card being unable to interrupt the operating system when in the polling mode for packets having low priority and being able to interrupt the system when in the polling mode for packets having high priority, further comprising:
receiving an interrupt from the network interface card when the network interface card is in the polling mode when the network interface card has received one or more packets having a high priority.

10. The method as recited in claim 2, further comprising:
ascertaining whether the network interface card is in an interrupt mode or a polling mode.

11. The method as recited in claim 2, further comprising:
placing the network interface card in the polling mode.

12. The method as recited in claim 2, further comprising:
placing the network interface card in the interrupt mode.

13. The method as recited in claim 2, further comprising:
initializing the network interface card such that the network interface card is in the interrupt mode.

14. The method as recited in claim 2, further comprising:
instructing the network interface card to switch from the polling mode to the interrupt mode.

15. The method as recited in claim 14, wherein instructing the network interface card to switch from the polling mode to the interrupt mode comprises instructing the network interface card to switch from the polling mode to the interrupt mode for a specified period of time.

16. The method as recited in claim 2, further comprising:
instructing the network interface card to switch from the interrupt mode to the polling mode.

17. The method as recited in claim 16, wherein instructing the network interface card to switch from the interrupt mode to the polling mode comprises instructing the network interface card to switch from the interrupt mode to the polling mode for a specified period of time.

18. The method as recited in claim 2, wherein the computer system further includes a CPU, the CPU having an associated queue, the network interface card having an associated buffer, the method further comprising:
if it is determined that one or more packets have been received by the network interface card, transferring the one or more packets from the buffer associated with the network interface card to the queue associated with the CPU and processing each of the packets in the queue associated with the CPU.

19. The method as recited in claim 2, wherein the computer system further includes a CPU, the CPU having an associated queue, the network interface card having an associated buffer, the method further comprising:
when an interrupt is received from the network interface card, transferring a set of one or more packets from the buffer associated with the network interface card to the queue associated with the CPU.

20. The method as recited in claim 19, wherein the set of packets are transferred simultaneously.

21. The method as recited in claim 19, further comprising:
instructing the network interface card to switch from the polling mode to the interrupt mode when no packets are in the queue associated with the CPU or the buffer associated with the network interface card.

22. The method as recited in claim 19, further comprising:
instructing the network interface card to switch from the interrupt mode to the polling mode when the interrupt is received from the network interface card.

23. The method as recited in claim 19, further comprising:
processing each of the packets in the queue.

24. The method as recited in claim 23, wherein each of the packets in the queue is inbound or outbound.

25. The method as recited in claim 23, wherein each of the packets in the queue corresponds to one or more network connections.

26. The method as recited in claim 23, further comprising:
instructing the network interface card to switch from the interrupt mode to the polling mode prior to processing each of the packets in the queue.

27. The method as recited in claim 23, further comprising:
instructing the network interface card to switch from the interrupt mode to the polling mode.

28. The method as recited in claim 27, further comprising:
after processing each of the packets in the queue, polling the network interface card to determine if one or more packets have been received by the network interface card in the buffer associated therewith; and
if one or more packets have been received by the network interface card, transferring the one or more packets from the buffer associated with the network interface card to the queue associated with the CPU and processing each of the packets in the queue associated with the CPU.

29. The method as recited in claim 28, further comprising:
if no more packets have been received by the network interface card, instructing the network interface card to switch from the polling mode to the interrupt mode.

30. The method as recited in claim 27, further comprising:
instructing the network interface card to switch from the polling mode to the interrupt mode after processing each of the packets in the queue.

31. The method as recited in claim 23, further comprising:
instructing the network interface card to switch from the polling mode to the interrupt mode after processing each of the packets in the queue.

32. The method as recited in claim 19, further comprising:
instantiating a worker thread for processing packets in the queue associated with the CPU.

33. The method as recited in claim 32, wherein the worker thread or a second worker thread is responsible for transferring the set of packets from the buffer associated with the network interface card to the queue associated with the CPU.

34. The method as recited in claim 32, wherein the worker thread is responsible for instructing the network interface card to switch from polling mode to interrupt mode when no packets are in the queue associated with the CPU or the buffer associated with the network interface card.

35. The method as recited in claim 32, wherein the worker thread is responsible for instructing the network interface card to switch from the interrupt mode to the polling mode after an interrupt is received from the network interface card.

36. The method as recited in claim 2, further comprising:
assigning an identifier to map one of a set of one or more CPUs in the computer system to one of a set of one or more network interface cards.

37. The method as recited in claim 36, further comprising:
instructing the network interface card identified by the identifier to enter the polling mode.

38. The method as recited in claim 36, further comprising:
instructing the network interface card identified by the identifier to enter the interrupt mode.

39. The method as recited in claim 36, wherein the interrupt includes the identifier.

40. The method as recited in claim 36, wherein the identifier is further associated with a queue associated with the CPU and a buffer associated with the network interface card.

41. The method as recited in claim 40, wherein the interrupt includes the identifier.

42. The method as recited in claim 40, further comprising:
instructing the network interface card identified by the identifier to switch from the polling mode to the interrupt mode.

43. The method as recited in claim 40, further comprising:
instructing the network interface card identified by the identifier to switch from the interrupt mode to the polling mode.

44. The method as recited in claim 2, further comprising:
instructing the network interface card to operate in the polling mode when a network packet that is received or to be transmitted is already being processed and one or more packets are queued; and
instructing the network interface card to operate in the interrupt mode when there are no queued packets.

45. A computer system, comprising:
an operating system; and
a network interface card coupled to the operating system, the network interface card being configured to operate in an interrupt mode when in a first state and to operate in polling mode when in a second state, the network interface card when in the interrupt mode being configured to interrupt the operating system when a packet is received by the network interface card over a network.

46. The computer system as recited in claim 45, the network interface card being unable to interrupt the operating system when in the polling mode, thereby enabling the operating system to poll the network interface card to obtain packets from the network interface card when the network interface card is in the polling mode.

47. The computer system as recited in claim 45, the network interface card being unable to interrupt the operating system when in the polling mode for packets having low priority and being able to interrupt the system when in the polling mode for packets having high priority.

48. The computer system as recited in claim 45, further comprising:
one or more CPUs.

49. The computer system as recited in claim 48, wherein the network interface card is mapped to one of the CPUS.

50. The computer system as recited in claim 49, wherein the network interface card is further mapped to a queue associated with the one of the CPUs, wherein the queue is adapted for storing inbound and outbound packets.

51. The computer system as recited in claim 45, further comprising:
means for instructing the network interface card to switch from the interrupt mode to the polling mode; and
means for instructing the network interface card to switch from the polling mode to the interrupt mode.

52. The computer system as recited in claim 45, further comprising:
a driver including a call interface between a kernel of the operating system and the network interface card, the call interface enabling the kernel of the operating system to instruct the network interface card to enter the interrupt mode or the polling mode.

53. An apparatus for processing packets in a computer system including an operating system and a network interface card, comprising:
means for polling the network interface card to determine whether one or more packets have been received when the network interface card is in a polling mode; and
means for receiving an interrupt from the network interface card when the network interface card is in an interrupt mode, the interrupt indicating that the network interface card has received one or more packets.

54. The apparatus as recited in claim 53, further comprising:
means for instructing the network interface card to switch from the interrupt mode to the polling mode; and
means for instructing the network interface card to switch from the polling mode to the interrupt mode.

55. The apparatus as recited in claim 53, the network interface card when in the interrupt mode being configured to interrupt the operating system when a packet is received by the network interface card over a network, the network interface card being unable to interrupt the operating system when in the polling mode, thereby enabling the operating system to poll the network interface card to obtain packets from the network interface card when the network interface card is in the polling mode.

56. The apparatus as recited in claim 53, the network interface card when in the interrupt mode being configured to interrupt the operating system when a packet is received by the network interface card over a network, the network interface card being unable to interrupt the operating system when in the polling mode for packets having low priority and being able to interrupt the system when in the polling mode for packets having high priority.

57. A computer-readable medium storing thereon computer readable instructions for processing packets in a computer system including an operating system and a network interface card, comprising:
instructions for polling the network interface card to determine whether one or more packets have been received when the network interface card is in a polling mode; and
instructions for receiving an interrupt from the network interface card when the network interface card is in an interrupt mode, the interrupt indicating that the network interface card has received one or more packets.

58. The computer-readable medium as recited in claim 57, further comprising:
instructions for instructing the network interface card to switch from the interrupt mode to the polling mode; and
instructions for instructing the network interface card to switch from the polling mode to the interrupt mode.

59. The computer-readable medium as recited in claim 57, the network interface card when in the interrupt mode being configured to interrupt the operating system when a packet is received by the network interface card over a network, the network interface card being unable to interrupt the operating system when in the polling mode, thereby enabling the operating system to poll the network interface card to obtain packets from the network interface card when the network interface card is in the polling mode.

60. The computer-readable medium as recited in claim 57, the network interface card when in the interrupt mode being configured to interrupt the operating system when a packet is received by the network interface card over a network, the network interface card being unable to interrupt the operating system when in the polling mode for packets having low priority and being able to interrupt the system when in the polling mode for packets having high priority.

61. A computer-readable medium storing thereon computer-readable instructions for configuring a network interface card, comprising:
instructions for instructing the network interface card to operate in a first mode when packets are received by the network interface card at less than a predefined rate, the network interface card in the first mode being capable of interrupting a CPU when a packet is received by the network interface card; and
instructions for instructing the network interface card to operate in a second mode when packets are received by the network interface card at greater than a predefined rate, the network interface card in the second mode being disabled from interrupting the CPU when a packet is received by the network interface card.

62. An apparatus for configuring a network interface card, comprising:
means for instructing the network interface card to operate in a first mode when packets are received by the network interface card at less than a predefined rate, the network interface card in the first mode being capable of interrupting a CPU when a packet is received by the network interface card; and
means for instructing the network interface card to operate in a second mode when packets are received by the network interface card at greater than a predefined rate, the network interface card in the second mode being disabled from interrupting the CPU when a packet is received by the network interface card.

63. An apparatus for configuring a network interface card, comprising:
a processor; and
a memory, at least one of the processor and the memory being adapted for:
instructing the network interface card to operate in a first mode when packets are received by the network interface card at less than a predefined rate, the network interface card in the first mode being capable of interrupting a CPU when a packet is received by the network interface card; and
instructing the network interface card to operate in a second mode when packets are received by the network interface card at greater than a predefined rate, the network interface card in the second mode being disabled from interrupting the CPU when a packet is received by the network interface card.
